(19) United States
(12) Patent Application Publication
(10) Pub. No.: US 2014/0210135 A1
(43) Pub. Date: Jul. 31, 2014

(54) METHOD OF FABRICATING A PERFLUOROSULFONATED IONOMER MEMBRANE WITH A MOLECULAR ALIGNMENT

(71) Applicant: Panasonic Corporation, Osaka (JP)

(72) Inventors: Masato AIZAWA, Osaka (JP); Tetsuaki HIRAYAMA, Osaka (JP); Hisaaki GYOTEN, Osaka (JP)

(73) Assignee: Panasonic Corporation, Osaka (JP)

(21) Appl. No.: 14/242,027

(22) Filed: Apr. 1, 2014

Related U.S. Application Data
(63) Continuation of application No. PCT/JP2013/004396, filed on Jul. 18, 2013.

(30) Foreign Application Priority Data
Aug. 2, 2012 (JP) 2012-171585

(51) Int. Cl. H01M 8/10

(52) U.S. Cl. CPC H01M 8/1093; H01M 8/1039
USPC 264/319

(57) ABSTRACT

The current disclosure provides a method of fabricating a perfluorosulfonated ionomer membrane with a surface having an array of a plurality of fine pillars. The pillars are fabricated by a rapid deformation of the membrane via thermal imprint lithography under appropriate temperatures and pressures. This fabrication process induces the molecular alignment of a polymer in the pillars. As a result, the main chain via C—F and C—C bonds in the pillar is controlled to reduce the proton transport resistance in the pillars. Therefore, the fuel cells utilizing the invented membrane show improved performance under low humidity.

### CROSS-REFERENCE TO RELATED APPLICATIONS

This is a continuation application of International Application No. PCT/JP2013/004396, with an international filing date of Jul. 18, 2013, which claims priority of Japanese Patent Application No. 2012-171585 filed on Aug. 2, 2012, the contents of which is incorporated herein by reference.

### BACKGROUND OF THE INVENTION

(1) Field of the Invention

The present disclosure relates to a method of fabricating a perfluorosulfonated ionomer membrane for a fuel cell, and more particularly, to a perfluorosulfonated ionomer (PFSI) membrane for a polymer electrolyte membrane fuel cell (PEMFC) and a direct methanol fuel cell (DMFC).

(2) Description of Related Art

It is publically known that PFSI membranes with large surface areas improve the performance of PEMFCs and DMFCs. Methods of embossing, thermal imprint lithography, and casting are disclosed to fabricate such large surface area membranes with fine bumpy structures.

Among them, embossing and thermal imprint lithography are categorized into the same fabrication method to form fine bumpy structures on a surface of a membrane. These methods involve a process of pressing a mold against a PFSI flat membrane surface at an appropriate pressure and temperature. Below, only thermal imprint lithography is used to represent the two terms with the same meaning.

A method of thermal imprint lithography to fabricate a PFSI membrane including its surface with an array of a plurality of fine bumps is disclosed in Japanese Laid-Open Patent Publication No. 2005-174620 (Patent Document 1), Japanese Laid-Open Patent Publication No. 2008-4486 (Patent Document 2), Y. Zhang, j. Lu, H. S. Zhou, T. itoh, and R. iviaeda, “Effects of the nanoimprint pattern on the performance of a MEMS-based micro direct methanol fuel cell”, Journal of Micromechanics and Microengineering, Institute of Physics Publishing, 2009, Vol. 19, Page 015003(6pp) (Non Patent Document 1) and M. Hakkan, Y. J. T. Braake, H. C. Aran, D. F. Stamatislis, and M. Wessling, “Micro-patterned Nafion membranes for direct methanol fuel cell applications”, Journal of Membrane Science, Elsevier Publishing, 2010, Vol. 349, Pages 231-236 (Non Patent Document 2).

The bumps are 0.3-50.0 micrometers in diameter (D) and length (H) with preferable aspect ratios (H/D) of 5-100 as disclosed in Japanese Laid-Open Patent Publication No. 2005-174620 (Patent Document 1).

Thermal imprint lithography is performed at a temperature of 170-300° C. to fabricate the fine bumps with a typical dimension of a few to 10 micrometers as disclosed in Japanese Laid-Open Patent Publication No. 2008-4486 (Patent Document 2).

Thermal imprint lithography is performed at a pressure of 3 MPa and a temperature of 130-135° C. as disclosed in Y Zhang, J. Lu, H. S. Zhou, T. itoh, and R. Maeda, Journal of Micromechanics and Microengineering, Institute of Physics Publishing, 2009, Vol. 19, Page 015003(6pp) (Non Patent Document 1) and M. Hakkan, Y. J. T. Braake, H. C. Aran, D. F. Stamatislis, and M. Wessling, Journal of Membrane Science, Elsevier Publishing, 2010, Vol. 349, Pages 231-236 (Non Patent Document 2). The bumps fabricated in Y. Zhang, J. Lu, H. S. Zhou, T. itoh, and R. Maeda, Journal of Micromechanics and Microengineering, Institute of Physics Publishing, 2009, Vol. 19, Page 015003(6pp) (Non Patent Document 1) are 0.6-2.0 micrometers in diameter and 60-800 nm in height. M. Hakkan, Y. J. T. Braake, H. C. Aran, D. F. Stamatislis, and M. Wessling, Journal of Membrane Science, Elsevier Publishing, 2010, Vol. 349, Pages 231-236 (Non Patent Document 2) discloses a line and space pattern. The line width and height are 19 micrometers and 20 micrometers, respectively.

As an alternative method, Japanese Patent No. 4920799 (Patent Document 3) discloses a method of casting to fabricate a PFSI membrane with an array of a plurality of fine bumps. In this method, the membrane is fabricated by casting a PFSI solution over a mold, followed by drying of the solution at a temperature of 130-200° C. The bumps are 5-15 micrometers in height.

As an additional prior art regarding the present disclosure, Japanese Laid-Open Patent Publication No. 2011-186092 (Patent Document 4) discloses a method of ultraviolet nanoimprint lithography to align the molecular structure of a liquid crystal polymer. A surface of the polymer possesses a fine line and space pattern with 0.2-2.0 micrometers in width. The main chain comprising C—C bonds of the polymer in the patterned line is oriented parallel to the line, which is useful to improve the manufacturing process of display and memory devices.

### SUMMARY

It is desired to improve PEMFC performance using a large surface area membrane under low humidity for its cost reduction. As a method of fabricating a large surface area membrane, thermal imprint lithography disclosed in Japanese Laid-Open Patent Publication No. 2005-174620 (Patent Document 1), Japanese Laid-Open Patent Publication No. 2008-4486 (Patent Document 2), Y. Zhang, J. Lu, H. S. Zhou, T. Itoh, and R. Maeda, Journal of Micromechanics and Microengineering, Institute of Physics Publishing, 2009, Vol. 19, Page 015003(6pp) (Non Patent Document 1) and M. Hakkan, Y. J. T. Braake, H. C. Aran, D. F. Stamatislis, and M. Wessling, Journal of Membrane Science, Elsevier Publishing, 2010, Vol. 349, Pages 231-236 (Non Patent Document 2) seems to be promising. However, the proton transport resistance in the fine bumps, particularly with high aspect ratios, disclosed in the prior arts becomes high under low humidity. Since protons are insufficiently delivered to the cathode electrode where the oxygen reduction reaction occurs, the PEMFC performance is degraded. The high proton transport resistance is due to the deformation of a polymer structure induced by applied pressure and temperature in the imprinting process.

The casting method is capable of forming the fine bumps on a membrane without applying pressure as disclosed in Japanese Patent No. 4920799 (Patent Document 3). As a result, the PEMFCs using the bumpy membranes show improved performance under low humidity. Unlike the present disclosure, this casting method is, however, unable to intentionally control the alignment of a polymer structure in the pillars. Moreover, since this fabrication method requires a long time of annealing process, it is not compatible with a high-throughput and large-scale fabrication process for high surface area membranes.

Therefore, it is necessary to invent a method of thermal imprint lithography which suppresses the proton transport resistance in the bumps under low humidity. Such thermal imprint lithography requires controlling the alignment of a polymer structure in the bumps, so that protons are effectively transported through the bumps.

Ultraviolet nanoimprint lithography provides a method of controlling the alignment of a polymer structure as disclosed in Japanese Laid-Open Patent Publication No. 2011-186092 (Patent Document 4). However, this method only aligns the main chain of the polymer parallel to the patterned line. Moreover, since a PFSI membrane is not softened by ultraviolet light, it is impossible to form the fine bumps on the membrane using this method.

In one general aspect, the techniques disclosed here feature: a method of thermal imprint lithography for fabricating a perfluorosulfonated ionomer membrane comprising a surface with an array of a plurality of fine pillars for a polymer electrolyte membrane fuel cell, the method including:

(a) preparing a mold comprising a surface having an array of a plurality of fine holes;

(b) disposing a perfluorosulfonated ionomer flat membrane on the surface of the mold prepared in the step (a); wherein the perfluorosulfonated ionomer flat membrane is formed of perfluorosulfonated polymer having a main chain of covalent C—F and C—C bonds;

(c) introducing parts of the perfluorosulfonated ionomer flat membrane into the fine holes of the mold by pressing the perfluorosulfonated ionomer flat membrane disposed on the mold in the step (b) at a pressure of not less than 3 MPa and not more than 10 MPa under a temperature of not less than 140 degrees Celsius and not more than 165 degrees Celsius, so as to obtain the perfluorosulfonated ionomer membrane comprising the surface having the array of the plurality of fine pillars; wherein each of the parts of the perfluorosulfonated ionomer flat membrane introduced into the fine holes of the mold has an orientation angle of not less than 47.2 degrees and not more than 52.0 degrees, the orientation angle being defined as an angle formed between the main chain and a longitude axis of the each of the fine pillars;

(d) cooling the perfluorosulfonated ionomer membrane obtained in the step (c) until the temperature of the perfluorosulfonated ionomer membrane obtained in the step (c) becomes below 110 degrees Celsius; and

(e) separating the perfluorosulfonated ionomer membrane from the mold.

In the invented membrane, the polymer structure in the pillars is aligned to reduce the proton transport resistance under low humidity. The molecular alignment is induced by a rapid deformation of the membrane surface at an appropriate temperature and pressure. As a result, PEMFCs using the invented membranes under low humidity show better performance than those utilizing the membrane with fine bumps prepared by the previously disclosed methods.

Additional benefits and advantages of the disclosed embodiments will be apparent from the specification and figures. The benefits and/or advantages may be individually provided by the various embodiments and features of the specification and drawings disclosure, and need not all be provided in order to obtain one or more of the same.

### BRIEF DESCRIPTION OF DRAWINGS

The present disclosure will become readily understood from the following description of non-limiting and exemplary embodiments thereof made with reference to the accompanying drawings, in which like parts are designated by like reference numeral and in which:

FIG. 1 shows the chemical structure of a perfluorosulfonated ionomer membrane;

FIG. 2 shows a part of a mold for thermal imprint lithography;

FIG. 3 shows the experimental setup for thermal imprint lithography;

FIGS. 4A and 4B show deformation mechanism of a perfluorosulfonated ionomer flat membrane;

FIG. 5 shows a pillar structure on a perfluorosulfonated ionomer membrane;

FIG. 6A shows a catalyst coated membrane;

FIG. 6B shows an interface between the membrane with a pillar structure and a cathode catalyst layer;

FIG. 7A shows a single pillar in a cathode catalyst layer;

FIG. 7B shows the definition of the orientation angle for a polymer structure in a pillar;

FIG. 8A shows experimental setups for backscattering Raman spectroscopy at a polarization angles (φ) of 0°;

FIG. 8B shows experimental setups for backscattering Raman spectroscopy at a polarization angles (φ) of 90°;

FIG. 9 shows a scanning electron micrograph of a part of a mold for thermal imprint lithography;

FIGS. 10A and 10B shows scanning electron micrographs of the pillar structure with a width of 2 micrometers, a height of 7 micrometers, and an inter-pillar distance of 6 micrometers;

FIG. 11 shows the analysis area on a pillar for Raman spectroscopy;

FIG. 12 shows the simplified structure of a Nafion membrane;

FIG. 13 shows Raman spectra for the membrane with a pillar structure at polarization angles (φ) of 0°, 45°, and 90°;

FIGS. 14A-14E show polarization angle dependences on the Raman intensities for the membrane with a pillar structure due to the C—F stretching mode (FIG. 14A), the C—C stretching mode (FIG. 14B), the S—O stretching mode (FIG. 14C), the normalized C—F stretching mode (FIG. 14D), and a normalized C—C stretching mode (FIG. 14E);

FIG. 15 shows Raman spectra for a flat membrane at polarization angles (φ) of 0°, 45°, and 90°;

FIGS. 16A-16E show polarization angle dependences on the Raman intensities for a flat membrane due to the C—F stretching mode (FIG. 16A), the C—C stretching mode (FIG. 16B), the S—O stretching mode (FIG. 16C), the normalized C—F stretching mode (FIG. 16D), and the normalized C—C stretching mode (FIG. 16E);

FIG. 17A shows a scanning electron micrograph of a catalyst coated membrane utilizing the membrane with a pillar structure and FIG. 17B shows a scanning electron micrograph of an enlarged interface between the membrane with a pillar structure and the cathode catalyst layer; and

FIG. 18 shows the fuel cell configuration.

### DETAILED DESCRIPTION

According to a first aspect, a method of thermal imprint lithography for fabricating a perfluorosulfonated ionomer membrane comprising a surface with an array of a plurality of fine pillars for a polymer electrolyte membrane fuel cell, the method including:

(a) preparing a mold comprising a surface having an array of a plurality of fine holes;

(b) disposing a perfluorosulfonated ionomer flat membrane on the surface of the mold prepared in the step (a); wherein the perfluorosulfonated ionomer flat membrane is formed of perfluorosulfonated polymer having a main chain of covalent C—F and C—C bonds;

(c) introducing parts of the perfluorosuifonated ionomer flat membrane into the fine holes of the mold by pressing the perfluorosulfonated ionomer flat membrane disposed on the mold in the step (b) at a pressure of not less than 3 MPa and not more than 10 MPa under a temperature of not less than 140 degrees Celsius and not more than 165 degrees Celsius, so as to obtain the perfluorosulfonated ionomer membrane comprising the surface having the array of the plurality of fine pillars; wherein each of the parts of the perfluorosulfonated ionomer flat membrane introduced into the fine holes of the mold has an orientation angle of not less than 47.2 degrees and not more than 52.0 degrees, the orientation angle being defined as an angle formed between the main chain and a longitude axis of the each of the fine pillars;

(d) cooling the perfluorosulfonated ionomer membrane obtained in the step (c) until the temperature of the perfluorosulfonated ionomer membrane obtained in the step (c) becomes below 110 degrees Celsius; and

(e) separating the perfluorosulfonated ionomer membrane from the mold.

Further, as a method of a second aspect, in the first aspect, the perfluorosulfonated ionomer flat membrane has a glass transition temperature falling within the range of 100 degrees Celsius to 160 degrees Celsius.

Appropriate examples are explained below in order to further clarify constituents and effects of the current disclosure. A preferred embodiment of the present disclosure is demonstrated hereinafter with reference to the accompanying drawings.

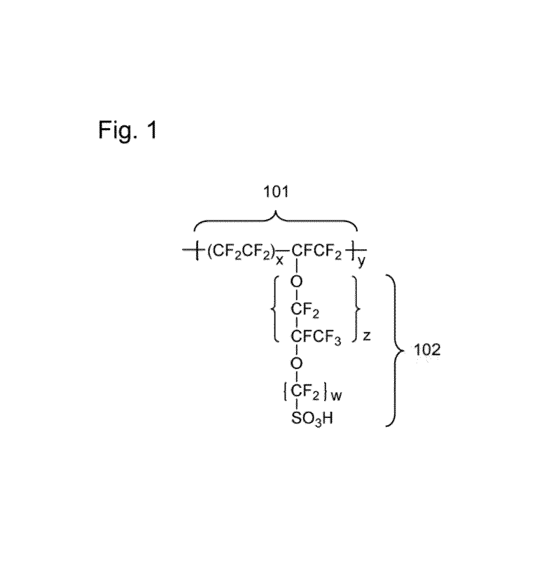

FIG. 1 shows the chemical structure of a PFSI membrane. The structure comprises the main chain via covalent C—F and C—C bonds 101 with a perfluorosulfonated side chain 102. Examples of commercially available PFSI flat membranes are Nafion by DuPont Corporation, Flemion by Asahi Glass Corporation, and Aciplex by Asahi Kasei Corporation.

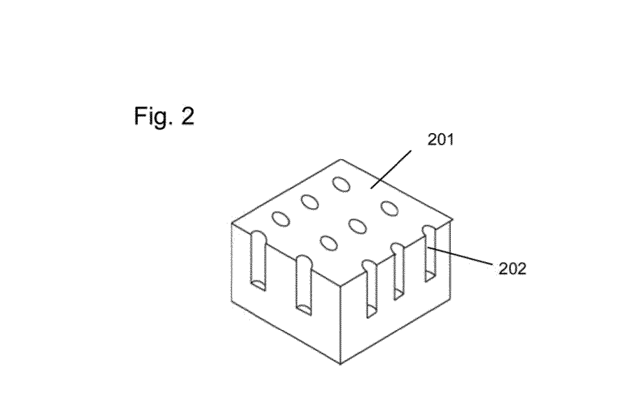

FIG. 2 shows a part of a mold 201 for thermal imprint lithography. The mold has an array of a plurality of fine holes 202. Silicon, quartz, and nickel are preferred materials for the mold. A tapered hole on the mold is preferred for easier separation of the mold from the membrane after imprinting. As a releasing layer, a fluorinated polymer layer with a thickness of less than 10 nm is preferably formed on the mold.

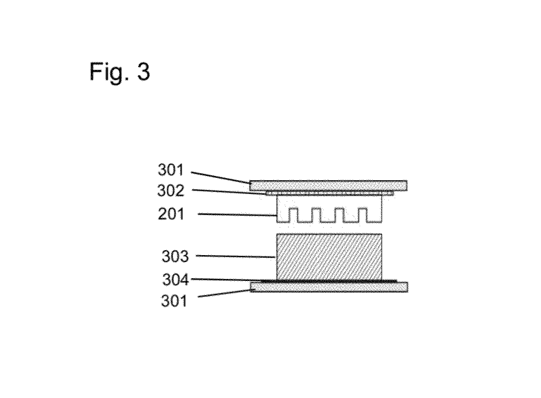

Thermal imprinting of a PFSI flat membrane is performed in the configuration shown in FIG. 3. The membrane 303 is attached to a polymer film 304. Preferably, the glass transition temperature of the polymer film 304 is much higher than that of the membrane 303, so that the polymer film 304 is not simultaneously deformed with the membrane 303 at imprinting.

After placing the mold 201 against the membrane 303, the entire sample is sandwiched between two plates 301. The plates 301 are preferably semiconductor wafers such as silicon wafers with flat and smooth surfaces, since they have heat durability under above imprint temperatures. Preferably, a surface of the plate 301 is coated by a fluorinated polymer layer to prevent the membrane 303 from sticking to the plate 301. A buffer sheet 302 is also placed between the mold 201 and the plate 301 to achieve perfect pattern transfer. Graphite and silicone rubber are the preferred materials for the buffer sheet 302.

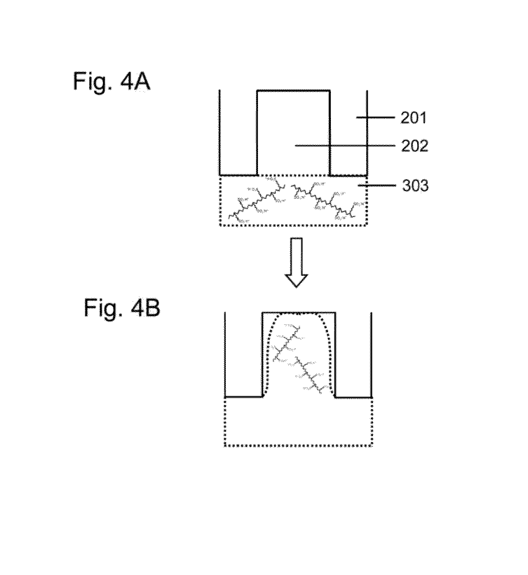

FIGS. 4A and 4B illustrate a deformation process of the membrane 303 by thermal imprint lithography. In other words, FIGS. 4A and 4B show how to introduce a part of the membrane into a hole 202 formed on the surface of the mold 201. The membrane 303 is introduced into the hole 202 formed on the mold 201 so as to form a pillar at a proper temperature and pressure. In order to deform the membrane surface, the imprint temperature needs to exceed the glass transition temperature (Tg) of the membrane. It is known that Tg of a perfluorosulfonated ionomer flat membrane is typically between 100 and 160° C. A required imprint temperature for the current disclosure is not less than 140° C. and not more than 165° C. The imprint temperature needs to be below the crystallization temperature of the membrane at which the membrane becomes a hard plastic accompanying with a color change. A required pressure for the current disclosure is not less than 3 MPa and not more than 10 MPa.

The imprint temperature for the present disclosure is higher than (130˜135)° C. disclosed in Y. Zhang, J. Lu, H. S. Zhou, T. Itoh, and R. Maeda, Journal of Micromechanics and Microengineering, Institute of Physics Publishing, 2009, Vol. 19, Page 015003(6pp) (Non Patent Document 1) and M. Hakkan, Y. J. T. Braake, H. C. Aran, D. F. Stamatislis, and M. Wessling, Journal of Membrane Science, Elsevier Publishing, 2010, Vol. 349, Pages 231-236 (Non Patent Document 2) but lower than 170° C. disclosed in Japanese Laid-Open Patent Publication No. 2008-4486 (Patent Document 2). Higher imprint pressure is also employed for the current disclosure, compared to 3 MPa disclosed in Non Patent Documents 1-2. High pressure imprint is essential for a rapid deformation of the membrane in order to control the alignment of the polymer structure. Only under these conditions, an array of fine pillars with a desired aspect ratio is formed on the membrane and the realignment of the polymer structure in the pillars occurs, as illustrated in FIGS. 4A and 4B.

If the imprint temperature is below 140° C., the resulting pillars are unable to obtain not only the desired aspect ratios of more than 1.5 but also lower the proton transport resistance in the pillars. If the imprint temperature is above 165° C., the resulting pillars begin to have higher proton transport resistance as a consequence of high temperature annealing of the pillars.

The imprint temperature of 140-165° C. for the present disclosure may be overlapped with that of 130-300° C. disclosed in Japanese Patent No. 4920799 (Patent Document 3). However, no pressure is applied to a membrane by the casting method employed in this prior art. Therefore, the casting method is unable to intentionally control the alignment of a polymer structure in the pillars, unlike this disclosure.

The imprint process is preferably conducted in a vacuum chamber. Since vacuum environment evacuates air in the hole 202 formed on the mold 201 in FIGS. 4A and 4B, the formation of an air void in the pillar is prevented at imprinting. After imprinting, cooling water is circulated through the heating blocks with keeping the pressure until the operating temperature reaches below the Tg of the membrane. The membrane attached to the mold is taken out of the imprinter and is further cooled to room temperature on a table. At last, the mold is carefully removed from the membrane.

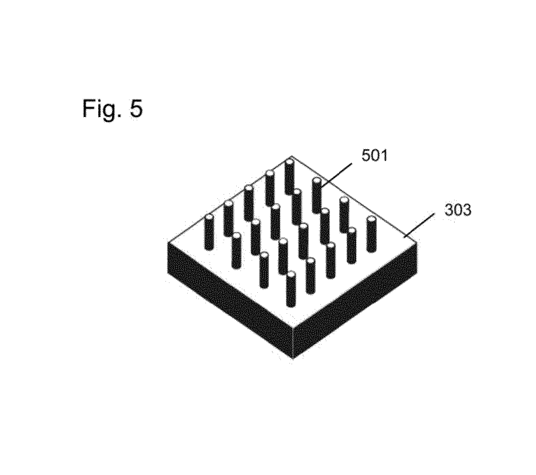

FIG. 5 shows a pillar structure formed on a surface of the membrane by thermal imprinting. A required height of a pillar 501 depends on the average thickness of a catalyst layer which will be deposited on the membrane in the fabrication process of a catalyst coated membrane. The height is preferably not less than 25% and not more than 83% of the catalyst layer thickness. A preferred aspect ratio of the pillar 501, given by the ratio of its height to diameter, is not less than 1.5 and not more than 5.0. The inter-hole distance is preferably less than 3 time of the diameter of the pillar 501.

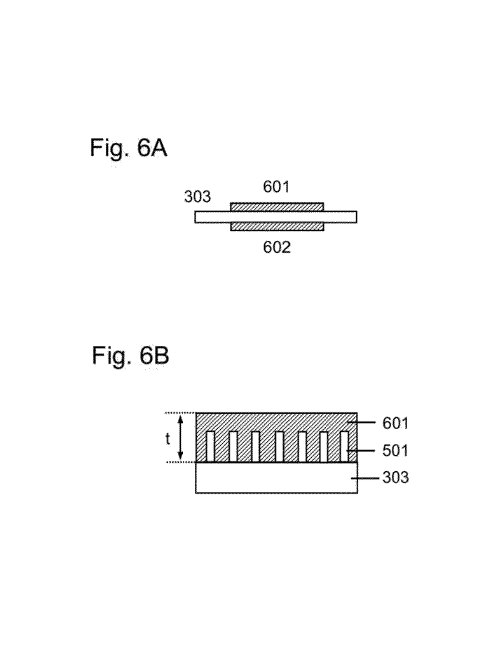

FIG. 6A shows a cross-sectional view of a catalyst coated membrane (CCM) fabricated by the formation of the cathode and anode catalyst layers (601 and 602) on both sides of the membrane 303. Both catalyst layers contain platinum or alloyed platinum nanoparticles supported on carbon and a proton conducting polymer electrolyte. Preferably, a membrane surface with the pillar structure is used for the cathode side while the flat surface is for the anode.

FIG. 6B shows an enlarged cross-sectional view of the interface between the membrane 303 and the cathode catalyst layer 601. The cathode catalyst layer 601 is formed on and between the pillars 501. The average thickness (t) of the cathode catalyst layer 601 is defined in this FIG. 6B for the discussion above.

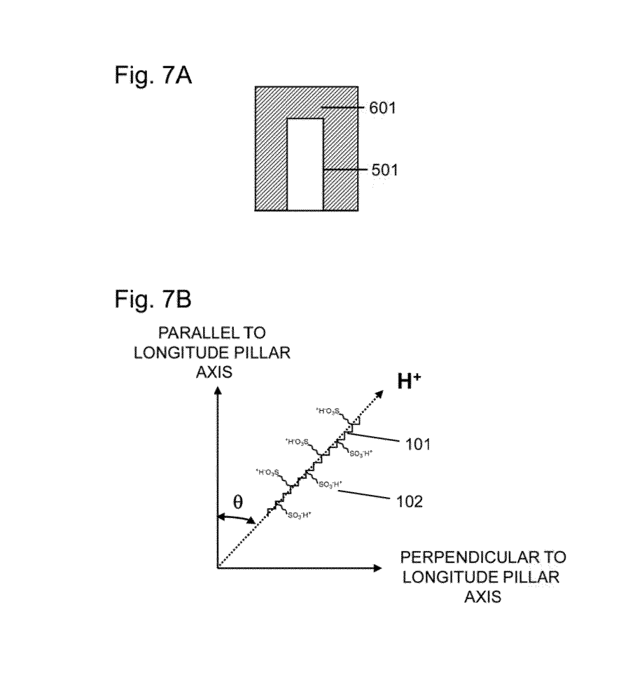

FIG. 7A shows a single pillar 501 surrounded by the cathode catalyst layer 601. The polymer structure in the pillar 501 consists of the main chain via the C—F and C—C bonds 101 with the perfluorosulfonated side chain 102, as shown in FIG. 7B. FIG. 7B also indicates the definition of orientation angle (θ) which is the angle formed between the main chain 101 and the longitude axis of pillar 501. However, it is not straightforward to experimentally determine the exact orientation angle for the fine pillars since the main chain 101 is not perfectly perpendicular with respect to the perfluorosulfonated side chains 102. Thus, the following method is preferred to evaluate the orientation angle.

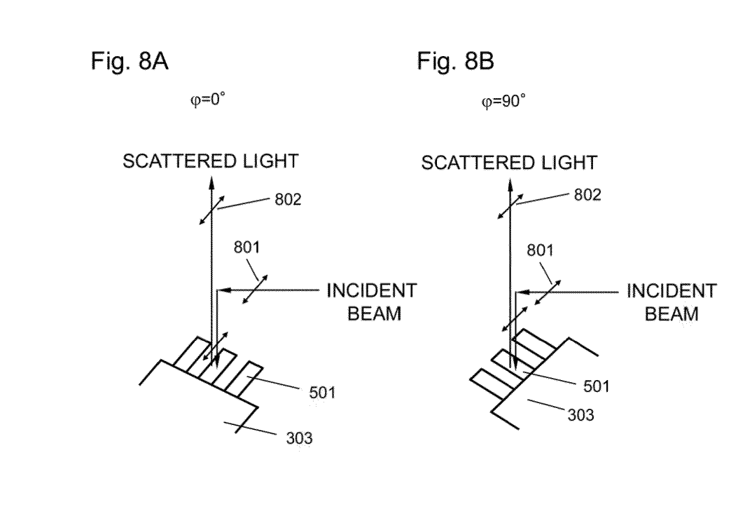

Polarized Raman spectroscopy can be used to evaluate the orientation angle of the polymer structure in the pillars. FIGS. 8A and 8B show examples of a backscattering Raman configuration to determine the orientation angle. An indent laser beam is focused on a spot of the pillar and the scattered light is analyzed by a CCD detector in the same direction as the incident beam. Moreover, the scattered light analysis is performed in such a way that a polarization direction 801 of the incident beam is fixed parallel to a polarization direction 802 of the scattered light.

In order to evaluate the molecular alignment of the polymer in the pillar, a series of Raman spectra for C—F, C—C, and S—O stretches are obtained by changing polarization angle (φ). The polarization angle (φ) is defined as the angle between the polarization direction of the incident beam and the longitude axis of the pillar, in this experimental setup, the polarization angle is changed by rotating the membrane with respect to the fixed polarization direction of the incident beam. The polarization angles are 0° (FIG. 8A) and 90° (FIG. 8B) when the polarization directions of the incident beam are parallel and perpendicular to the longitude axis of the pillar, respectively.

The orientation angle (θ) is approximated in the following spherical harmonic function:

$$θ = \frac{1}{2} {cos}^{- 1} \{ \frac{1}{3} ( \frac{4 ( f - 1 )}{f + 2} - 1 ) \}$$

where the orientation parameter (f) is defined as:

$$f = \frac{{( C - {F}_{stretch} )}_{norm , 90 °}}{{( C - {F}_{stretch} )}_{norm , 0 °}}$$

Here, (C—F stretch)_{norm,90°} and (C—F stretch)_{norm,0°} are Raman intensities for the C—F stretch at the polarization angles of 90° and 0°, respectively. The C—F intensities are normalized by the intensity of a randomly oriented chemical bond such as the S—O bond in the polymer molecule at the same polarization angle. It should be noted that the orientation angle obtained in this method does not necessarily mean the exact inclination of the main chain with respect to the longitude axis of the pillar.

If the main chain of the polymer has a complete random orientation, the orientation angle (θ) is known to be the “magic” angle of 54.9° with a spherical harmonic approximation. By referring to FIG. 7B, if the orientation angle is more than 54.9°, the main chain is leaned perpendicular to the longitude axis of the pillar. If the orientation angle is less than 54.9°, the main chain is leaned parallel to the longitude axis of the pillar.

The polymer for a flat PFSI membrane has a measured orientation angle of 56.6°. Therefore, the main chain is slightly leaned perpendicular to the longitude axis of the pillar, compared to that for the case of the random orientation.

The orientation angle of the polymer for reducing the proton transport resistance in the pillar is not less than 47.2° and not more than 52.0°. These angles are smaller than 56.6° observed for the flat membrane. This means that the main chain in the pillar is 4.6-9.4° leaned parallel to the longitude axis of the pillar, compared to that in the flat membrane.

The invented membranes with the pillar structures improve the PEMFC performance by decreasing the proton transport resistance in the pillars. The reduction in the proton transport resistance is due to the molecular alignment of the polymer in the pillars induced by thermal imprint lithography. Since the main chain of the polymer in the pillars is slightly tilt parallel to the longitude axis of the pillar, protons are effectively transported form the anode to the cathode with reduced resistance.

### EXAMPLE 1

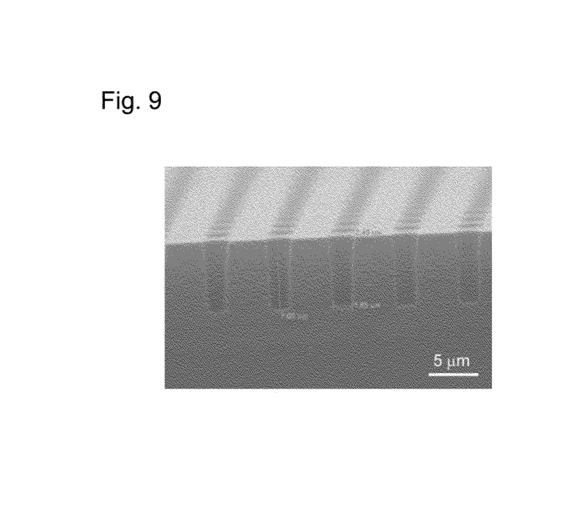

Photolithography based on a BOSCH etching process was performed to form a periodic tapered hole structure on a 4″ single crystal Si wafer. An area having the hole structure was 60 mm×60 mm. FIG. 9 shows a cross-sectional view of the hole structure. The tapered holes have an upper-width of 2.5 micrometers, a bottom-width of 1.9 micrometers, a depth of 7.0 micrometers, and an inter-hole distance of 6.0 micrometers.

A silicon mold for thermal imprint lithography was fabricated by cutting out the hole structure region from the wafer. The mold was degreased in ethanol, followed by acetone. Then, it was further cleaned by a UV-ozone stripper at 110° C. for 10 min. A self-assembled monolayer (SAM) of fluorinated polymer (NANOS B, T&K Corp.) was deposited on the mold by vacuum evaporation.

Thermal imprinting of a PFSI membrane was performed in the experimental setup shown in FIG. 3. A 150 mm×150 mm Nafion membrane with 50 micrometers thickness (NRE212, DuPont Corp.) was heat-laminated to a polyimide film with 30 micrometers thickness (Kapton, Toray-DuPont Corp.) in vacuum at 40° C. for 2 min. After placing the mold against the membrane, the entire sample was sandwiched between two 8″ Si wafers with their surfaces coated by the SAM. The SAM prevents the membrane from sticking to the wafer. A graphite sheet was also placed between the mold and the wafer to achieve perfect pattern transfer. The Nafion membrane used in the present example had a glass transition temperature of 110 degrees Celsius.

Thermal imprinting was conducted at a pressure of 10 MPa and a temperature of 150° C. for 10 min in vacuum by X-300 Nanoimprinter (Scivax Corporation). After the imprint process, cooling water was circulated through the heating blocks of the imprinter with keeping the pressure until the operating temperature reached 50° C. The temperature was lowered at an approximate cooling rate of 5° C./min. The membrane attached to the mold was removed from the imprinter and further cooled to a room temperature on a table. The mold was slowly separated from the membrane.

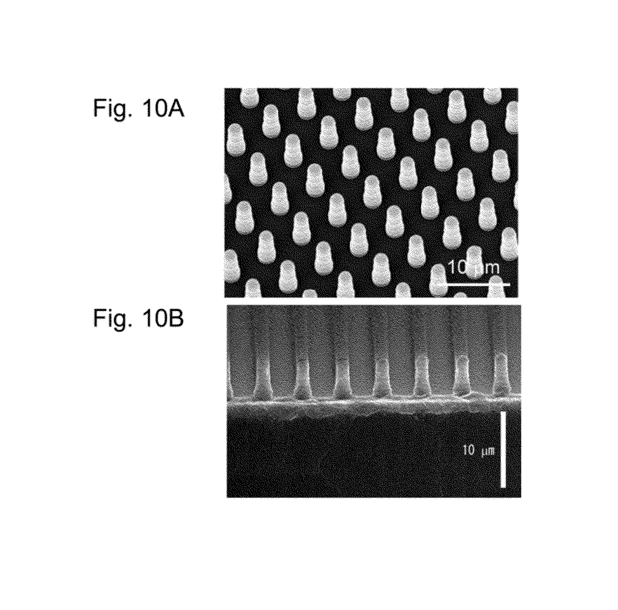

FIGS. 10A and 10B show a surface of the resulting membrane with a micron-sized pillar structure. The membrane has an array of a plurality of fine tapered pillars with an upper-width of 2.0 micrometers, a bottom-width of 2.5 micrometers, a height of 7.3 micrometers, and an inter-pillar distance of 6.0 micrometers. The pillar structure is symmetric to the hole structure of the mold.

### EXAMPLE 2

The same fabrication procedures described in Example 1 produced a silicon mold with its surface having an array of plurality of holes. The holes had the same upper and bottom width, and inter-hole distance as those described in Example 1 but a different depth of 10.1 micrometers. The thermal imprint process utilized in Example 1 was also applied to a Nafion membrane using the mold. A surface of the resulting membrane had an array of a plurality of pillars, each of which has the same upper and bottom width, and inter-pillar distance as those described in Example 1 but a different height of 10.1 micrometers. The term “same” used above means the agreement within an experimental error of ±0.5 micrometers.

### EXAMPLE 3

The same fabrication procedures described in Example 1 produced a silicon mold with its surface having an array of plurality of holes. The holes had the same upper and bottom width, and inter-hole distance as those described in Example 1 but a different depth of 3.1 micrometers. The thermal imprint process utilized in Example 1 was applied to a Nafion membrane using the mold. A surface of the resulting membrane had an array of a plurality of pillars, each of which has the same upper and bottom width as those described in Example 1 but a different height of 3.1 micrometers.

### EXAMPLE 4

The same pillar structure with its height of 7.0 micrometers described in Example 1 was formed on a Nafion membrane using the same fabrication procedures. However, the imprint pressure was changed to 7 MPa.

### EXAMPLE 5

The same pillar structure with its height of 10.0 micrometers described in Example 2 was formed on a Nafion membrane using the same fabrication procedures. However, the imprint pressure was changed to 7 MPa.

### EXAMPLE 6

The same pillar structure with its height of 3.0 micrometers described in Example 3 was formed on a Nafion membrane using the same fabrication procedures. However, the imprint pressure was changed to 7 MPa.

### EXAMPLE 7

The same pillar structure with its height of 7.0 micrometers described in Example 1 was formed on a Nafion membrane using the same fabrication procedures. However, the imprint pressure was changed to 3 MPa.

### EXAMPLES 8

The same pillar structure with its height of 3.0 micrometers described in Example 3 was formed on a Nafion membrane using the same fabrication procedures. However, the imprint pressure was changed to 3 MPa.

### EXAMPLES 9

The same pillar structure with its height of 7.0 micrometers described in Example 4 was formed on a Nafion membrane using the same fabrication procedures. However, the imprint temperature was changed to 165° C.

### EXAMPLES 10

The same pillar structure with its height of 10.0 micrometers described in Example 5 was formed on a Nafion membrane using the same fabrication procedures. However, the imprint temperature was changed to 165° C.

### EXAMPLES 11

The same pillar structure with its height of 3.0 micrometers described in Example 6 was formed on a Nafion membrane using the same fabrication procedures. However, the imprint temperature was changed to 165° C.

### EXAMPLES 12

The same pillar structure with its height of 3.0 micrometers described in Example 6 was formed on a Nafion membrane using the same fabrication procedures. However, the imprint temperature was changed to 140° C.

The same imprint temperature and pressure used in Example 12, were tried to form the same pillar structures with their heights of 7.0 micrometers and 10.0 micrometers described in Examples 4 and 5, respectively, on a Nafion membrane. However, the resulting pillar heights turned out to be only 5.0 micrometers.

### COMPARATIVE EXAMPLE 1

The same pillar structure with its height of 3.0 micrometers described in Example 3 was formed on a Nafion membrane using the same fabrication procedures. However, the imprint temperature and pressure were changed to 135° C. and 3 MPa, respectively. These imprint conditions were employed in Y. Zhang, J. Lu, H. S. Zhou, T. Itoh, and R. Maeda, Journal of Micromechanics and Microengineering, Institute of Physics Publishing, 2009, Vol. 19, Page 015003(6pp) (Non Patent Document 1) and M. Hakkan, Y. J. T. Braake, H. C. Aran, D. F. Stamatislis, and M. Wessling, Journal of Membrane Science, Elsevier Publishing, 2010, Vol. 349, Pages 231-236 (Non Patent Document 2).

The same imprint temperature and pressure used in Comparative Example 1, were tried to form the same pillar structures with their heights of 7.0 micrometers and 10.0 micrometers described in Example 1 and 2, respectively, on a Nafion membrane. However, the resulting pillar heights turned out to be only 3.0 micrometers.

### COMPARATIVE EXAMPLE 2

The same pillar structure with its height of 7.0 micrometers described in Example 1 was formed on a Nafion membrane using the same fabrication procedures. However, the imprint temperature was changed to 170° C. This imprint temperature was employed in Japanese Laid-Open Patent Publication No. 2008-4486 (Patent Document 2).

### COMPARATIVE EXAMPLE 3

No thermal imprinting was performed on a Nafion membrane. Both surfaces of the membrane were flat as received.

### COMPARATIVE EXAMPLE 4

The same pillar structure with its height of 7.0 micrometers described in Example 1 was tried to form on a Nafion membrane using the same fabrication procedures. However, the imprint temperature was changed to 180° C. which is the crystallization temperature of the membrane. The resulting membrane became a hard brown plastic with crack. Therefore, it was unable to evaluate the fuel cell performance explained below.

Table 1-1 and Table 1-2 summarize properties of all the membranes fabricated in terms of imprint temperature and pressure, pillar height, and pillar aspect ratio.

TABLE 1-1

| | Example | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Imprint Temperature | 150 | | | | | | | | 165 | | | 140 |
| (° C.) | | | | | | | | | | | | |
| Imprint Pressure | 10 | | | 7 | | | 3 | | 7 | | | 7 |
| (MPa) | | | | | | | | | | | | |
| Pillar Height (mm) | 7 | 10 | 3 | 7 | 10 | 3 | 7 | 3 | 7 | 10 | 3 | 3 |
| Pillar Aspect Ratio, | 3.5 | 5.0 | 1.5 | 3.5 | 5.0 | 1.5 | 3.5 | 1.5 | 3.5 | 5.0 | 1.5 | 1.5 |
| Pillar Height/Width | | | | | | | | | | | | |
| Orientation | 1.72 | 1.60 | 1.62 | 1.49 | 1.45 | 1.49 | 1.22 | 1.20 | 1.56 | 1.52 | 1.52 | 1.45 |
| Parameter, f | | | | | | | | | | | | |
| Orientation Angle | 47.2 | 48.2 | 48.0 | 49.2 | 49.6 | 49.2 | 52.0 | 52.0 | 48.5 | 48.9 | 48.9 | 49.6 |
| (degree) | | | | | | | | | | | | |
| Max. PEMFC | 312 | 293 | 285 | 290 | 288 | 279 | 278 | 277 | 295 | 291 | 286 | 275 |
| Power Density | | | | | | | | | | | | |
| (mW/cm²) | | | | | | | | | | | | |
| Cell Resistance, R | 260 | 255 | 282 | 274 | 276 | 286 | 287 | 288 | 270 | 275 | 285 | 290 |
| (mΩcm²) | | | | | | | | | | | | |
| Relative Proton | −33 | −38 | −11 | −19 | −17 | −7 | −6 | −5 | −23 | −18 | −8 | −3 |
| Transport Resistance | | | | | | | | | | | | |
| R (Comparative | | | | | | | | | | | | |
| Example 1)-R, | | | | | | | | | | | | |
| (mΩcm²) | | | | | | | | | | | | |

TABLE 1-2

| | Comparative | | |
|---|---|---|---|
| | Example | | |
| | 1 | 2 | 3 |
| Imprint Temperature | 135 | 170 | N/A |
| (° C.) | | | |
| Imprint Pressure | 3 | 10 | N/A |
| (MPa) | | | |
| Pillar Height (mm) | 3 | 7 | N/A |
| Pillar Aspect Ratio, | 1.5 | 3.5 | N/A |
| Pillar Height/Width | | | |
| Orientation Parameter, f | 1.03 | 1.60 | 0.87 |
| Orientation Angle | 54.4 | 48.2 | 56.6 |
| (degree) | | | |
| Max. PEMFC | 270 | 250 | 263 |
| Power Density | | | |
| (mW/cm²) | | | |
| Cell Resistance, R | 293 | 311 | 302 |
| (mΩcm²) | | | |
| Relative Proton | 0 | +18 | +9 |
| Transport Resistance | | | |
| R (Comparative | | | |
| Example 1)-R, | | | |
| (mΩcm²) | | | |

A Raman microscope (Mars 320, Photon Design Corp.) using the experimental configurations shown in FIGS. 8A and 8B were utilized to evaluate the molecular orientation of the polymer in the pillars prepared above. Prior to the analysis, the membrane thickness was reduced to 2 micrometers in order to eliminate the effect of fluorescence.

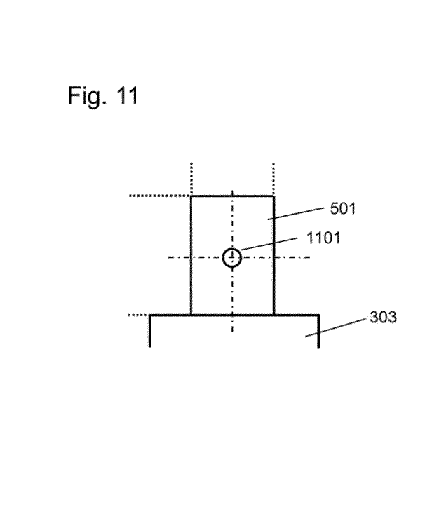

A 40 mW incident argon laser with a wavelength of 514 nm was focused on a 1 micrometer spot in the center of a pillar by an objective lens of one hundred magnifications. The position of the beam spot on the pillar is illustrated in FIG. 11. The scattered light was detected by a CCD detector (Japan Roper Corp.) after running through an aperture and a slit with a 200 micrometers and a 100 micrometers opening, respectively. The scattered light was analyzed in the same direction as the incident beam. Moreover, the scattered light analysis was performed in such a way that the polarization direction of the incident beam was fixed parallel to that of the scattered light, as shown in FIGS. 8A and 8B.

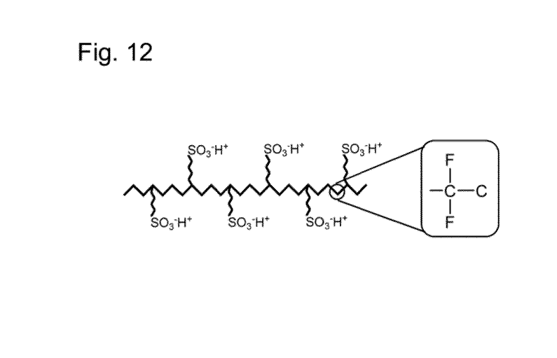

FIG. 12 shows the simplified chemical structure of a Nafion membrane. The main “zigzag” chain of the polymer comprises Teflon-like C—F and C—C bonds. The C—F and the C—C bonds are nearly perpendicular and parallel to the main chain, respectively. Proton conducting —SO₃H groups are bonded to the side chain as a pendant.

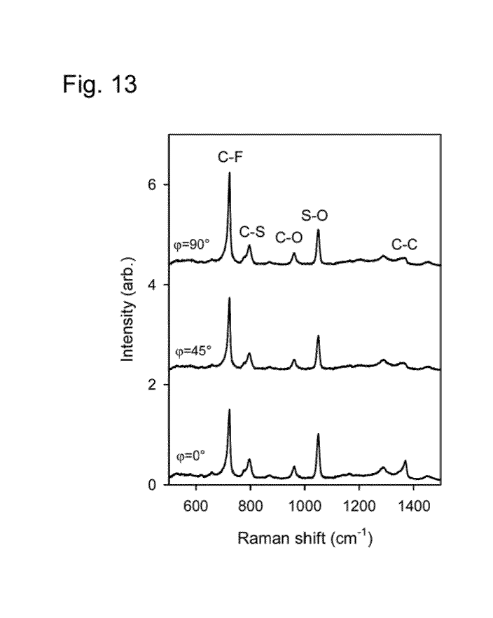

FIG. 13 shows Raman spectra for the pillar with a height of 7 micrometers in Example 4 at polarization angles of 0°, 45°, and 90°. Here, the polarization angle (φ is defined as the angle between the polarization direction of the incident beam and the longitude axis of the pillar, as explained in Embodiment. Raman peak intensities due to the C—C stretch at 1370cm⁻¹, the C—F stretch at 725cm⁻¹, and the S—O stretch at 1050cm⁻¹ are important to determine the molecular orientation in the pillar.

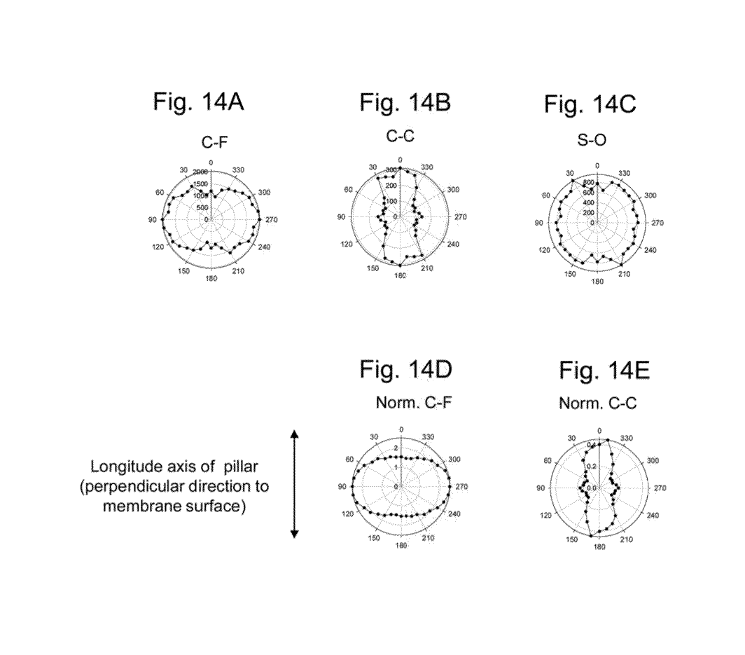

FIGS. 14A, 14B, and 14C were obtained by plotting the Raman intensities for the C—F, the C—C, and the S—O stretches as a function of polarization angle between 0° and 360° for the pillar with a height of 7.0 micrometers in Example 4. The angular dependence provides information regarding the anisotropy of each chemical bond. The C—F and the C—C bonds show a relatively strong angular dependence while the S—O bond does not. The results indicate that the S—O bond is randomly oriented. To quantitatively determine the orientations of the C—F and the C—C bonds, their peak intensities are normalized by that of the isotropic S—O bond. FIGS. 14D and 14E show the normalized C—F and the C—C intensities as a function of polarization angle.

The normalized C—F and the C—C intensities shows intense peaks towards polarization angles (φ) of 90° (270°) and 0° (180°), respectively. Here,) φ=0° (180°) indicates the parallel direction towards the longitude axis of a pillar, as shown in FIGS. 14A-14E. Based on the fact that the C—C bond is parallel to the main chain of the polymer, as shown in FIG. 12, the main chain in the pillar has a tendency to align parallel to the direction of the longitude axis of the pillar.

For the case of the pillar with a height of 7.0 micrometers in Example 4, the normalized C—F intensities at polarization angles of 90° and 0°, (C—F stretch)_{norm,90°} and (C—F stretch)_{norm,0°} are 2.48 and 1.66, respectively. By using the equations (1) and (2), the orientation angle (θ) and the orientation parameter (f) were calculated to be 49.2° and 1.49, respectively.

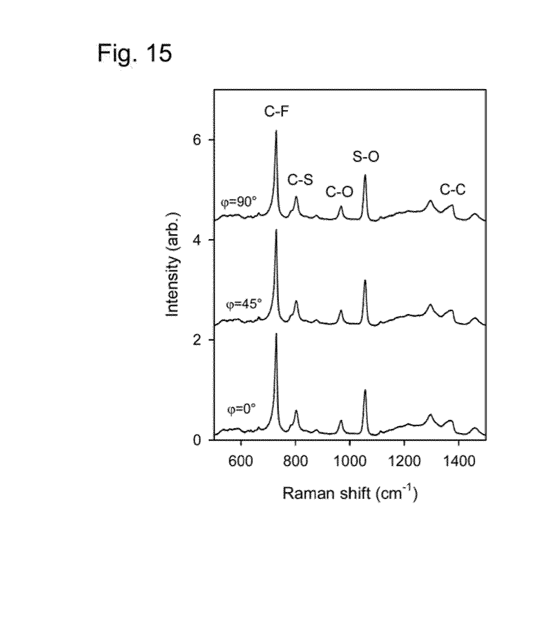

FIG. 15 shows Raman spectra for the flat membrane in Comparable Example 3 at polarization angles (φ) of 0°, 45°, and 90°. The analysis was performed on a spot which was 10 micrometers away from the membrane surface using a cross sectional sample.

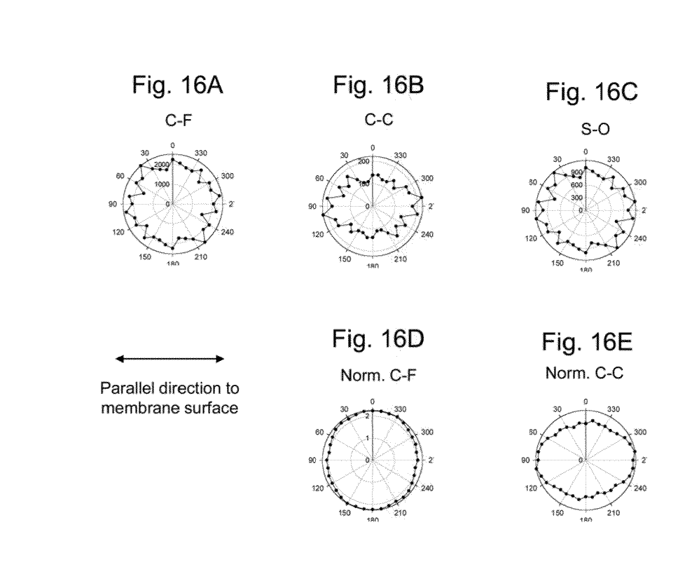

FIGS. 16A, 16B, and 16C show the peak intensity dependence for the C—F, the C—C, and the S—O stretches on polarization angle between 0 and 360° for the flat membrane. FIGS. 16D and 16E are the 16C-16F and the C—C intensities normalized by that of the nearly isotropic S—O bond.

In contrast to the plots for the membrane with the pillar structure in FIG. 14, the C—F and the C—C bonds shows peaks towards polarization angles (φ) of 0° (180°) and 90° (270°), respectively. For the flat membrane φ=90° (270°) indicates the parallel direction towards the membrane surface as shown in FIGS. 16A-16E. Since the C—C bond is parallel to the main chain of the polymer, as shown in FIG. 12, the main chain in the flat membrane has a tendency to align parallel to the direction of the membrane surface.

For the case of the flat membrane in Comparable Example 3, the normalized C—F intensities at polarization angles of 90° and 0°, (C—F stretch)_{norm, 90°} and (C—F stretch)_{norm, 0°} are 2.06 and 2.36, respectively. By using the equations (1) and (2), the orientation angle (θ) and the orientation parameter (f) were calculated to be 56.6° and 0.87, respectively.

The same Raman spectroscopy was performed for the rest of the pillars in Examples 1-3, 5-12, and Comparative Examples 1-2. Table 1-1 and Table 1-2 summarize the orientation parameters (f) and orientation angles (θ). The orientation angles for all the pillars in Examples 1-12 are smaller than those in Comparative Examples 1 and 3. The main chain of the polymer in the pillars for the present disclosure (Examples 1-12) is 2.4-7.2° (vs. Comparative Example 1) and 4.6-9.4° (vs. Comparative Example 3) leaned towards the longitude axis of the pillars. The orientation angle for Comparative Example 2 is comparable to that for Example 2.

In general, the smaller orientation angle is obtained by forming taller pillars under higher imprint pressure and temperature since larger deformation forces are imparted in the pillars. The effect of imprint temperature is smaller that those of imprint pressure and pillar height.

Platinum nanoparticles supported on Ketchen black with a platinum weight ratio of 48.3% (TEC10E50E, Tanaka Kikinzoku Corp.) were utilized for the catalyst. A catalyst slurry was produced by mixing the 5% Nafion solution (equivalent weight: 1100), water (18.2 MΩ), and ethanol (99.8%) with the supported platinum catalyst. The weight ratios of carbon to Nafion and of water to ethanol in the slurry were 0.8 and 1.0, respectively.

A catalyst coated membrane (CCM) was fabricated by spray deposition of the cathode and the anode catalysts onto the membrane. The membrane with the pillar side up was placed on a porous stainless steel plate heated at 50° C. It was then vacuum-attached to the plate. The catalyst slurry was sprayed over a 60 mm×60 mm area with the pillar structure which served as the cathode. The average thickness (t), defined in FIG. 6B, of the cathode catalyst layer was 12 micrometers. The cathode catalyst layer contained 0.3 mg/cm² of platinum. For the flat side of the membrane used as the anode, 0.2 mg/cm² of platinum was included in the catalyst layer.

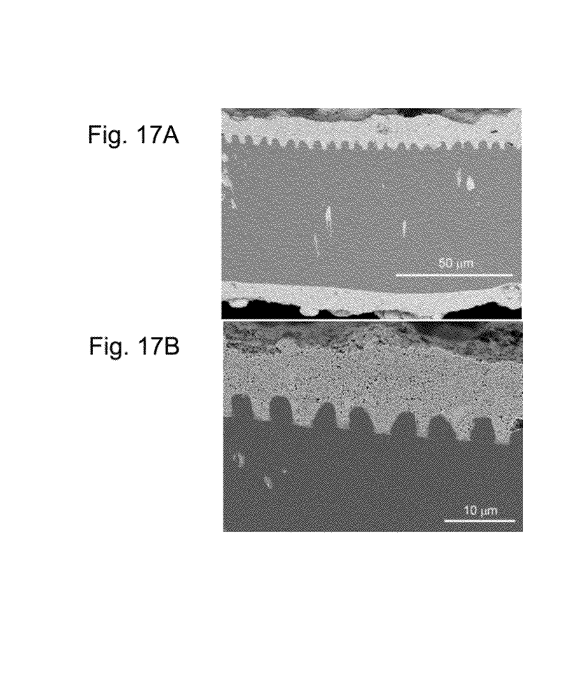

As an example, FIGS. 17A and 17B show cross-sectional electron micrographs obtained for the CCM using the membrane prepared in Example 4. The dark-colored intermediate layer in FIG. 17A represents the membrane. The light-colored layers in the upper and bottom show the cathode and the anode catalyst layers, respectively. As shown in FIG. 17B, the cathode catalyst layer was deposited between and on the individual pillars.

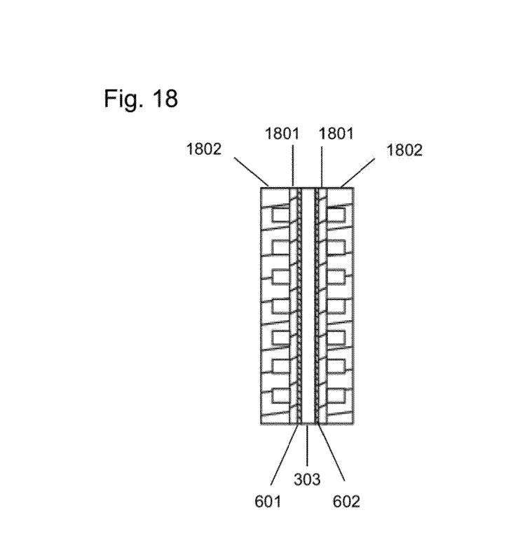

A membrane electrode assembly (MEA) was constructed by sandwiching the CCM between two gas diffusion media 1801 with microporous layers (GDL24, SGL Carbon). A single fuel cell shown in FIG. 18 was constructed by sandwiching the MEA between graphite collector/separator plates 1802 with single serpentine gas flow fields. The compression pressure applied on the MEA was kept uniform by measuring it with pressure sensitive papers.

Cell voltages and resistances were simultaneously recorded as a function of current density. The data were acquired at a cell temperature of 75° C. with feeding hydrogen and air into the anode and the cathode, respectively, by bubbling them through water controlled at 45° C. The calculated relative humidity of the reactant gases was 25%. Table 1-1 and Table 1-2 summarize the maximum PEMFC power density and the cell resistance obtained for all the membranes at a cell temperature of 75° C. and a relative humidity of 25%.

The maximum power densities for PEMFCs using the invented membranes in Examples 1-12 are higher than those in Comparable Examples 1-3. An advantage of the invented membranes over the comparable membranes is 5-62 mW/cm², depending on imprint temperature, pressure, and pillar height. The membrane with a pillar height of 7 micrometers provides the best fuel cell performance at the same imprint temperature and pressure. The cell performance improves with increasing imprint pressure from 3 to 10 MPa at the same imprint temperature and pillar height.

The cell resistance recorded by a resistance meter (Model: 3566, Tsuruga Electric Corporation) at a frequency of 1 kHz is also summarized in Table 1-1 and Table 1-2. The resistance for all the invented membranes in Examples 1-12 is 3-38 mΩcm² lowered than that for the membrane in Comparable Example 1. The cell resistance for Comparative Example 2 is higher than those for Comparative Examples 1 and 3. This is due to the highest imprint temperature of 170° C., which damages proton conducting —SO₃H groups by dehydration. As a proof of this argument, the color of a membrane imprinted at 170° C. turned a light brown, which was an indicative of the membrane degradation.

The cell resistance is a sum of the proton transport resistance, the contact resistance, and the electronic resistance. Since the electronic resistance is negligible compared to the others, the reduction in the cell resistance is mainly due to the decrease in the proton transport resistance and/or the contact resistance. It is disclosed that the molecular alignment of the polymer for perfluorosulfonated membranes has a great impact on the proton transport resistance in the membrane (B. Dong, L. Gwee, D. S. Cruz, K. I. Winey, and Y. A. Elabd, Nano Letters, 2010, volume 10, pp 3785-3790). In addition, there is an obvious correlation between the orientation angle and the cell resistance, as shown in Table 1-1 and Table 1-2. Therefore, it is considered that the reduction in the cell resistance largely corresponds to that in the proton transport resistance.

The bottom column in Table 1-1 and Table 1-2 summarize the relative proton transport resistance which is calculated by subtracting the cell resistance for the membrane in Comparable Example 1 from that for the membrane in Examples 1-12 and Comparable Examples 2 and 3. The more this value becomes negative, the smaller the proton transport resistance is. It should be noted that the proton transport resistance decreases as the orientation angle becomes smaller. As a result, the PEMFCs show better performance as the orientation angle decreases.

The present disclosure provides a method of fabricating a perfluorosulfonated ionomer membrane to improve the performance of a fuel cell under low humidity.

1. A method of thermal imprint lithography for fabricating a perfluorosulfonated ionomer membrane comprising a surface with an array of a plurality of fine pillars for a polymer electrolyte membrane fuel cell, the method comprising:
(a) preparing a mold comprising a surface having an array of a plurality of fine holes;
(b) disposing a perfluorosulfonated ionomer flat membrane on the surface of the mold prepared in the step (a); wherein the perfluorosulfonated ionomer flat membrane is formed of perfluorosulfonated polymer having a main chain of covalent C—F and C—C bonds;
(c) introducing parts of the perfluorosulfonated ionomer flat membrane into the fine holes of the mold by pressing the perfluorosulfonated ionomer flat membrane disposed on the mold in the step (b) at a pressure of not less than 3 MPa and not more than 10 MPa under a temperature of not less than 140 degrees Celsius and not more than 165 degrees Celsius, so as to obtain the perfluorosulfonated ionomer membrane comprising the surface having the array of the plurality of fine pillars; wherein each of the parts of the perfluorosulfonated ionomer flat membrane introduced into the fine holes of the mold has an orientation angle of not less than 47.2 degrees and not more than 52.0 degrees, the orientation angle being defined as an angle formed between the main chain and a longitude axis of the each of the fine pillars;
(d) cooling the perfluorosulfonated ionomer membrane obtained in the step (c) until the temperature of the perfluorosulfonated ionomer membrane obtained in the step (c) becomes below 110 degrees Celsius; and
(e) separating the perfluorosulfonated ionomer membrane from the mold.

2. The method according to claim 1, wherein the perfluorosulfonated ionomer flat membrane has a glass transition temperature falling within the range of 100 degrees Celsius to 160 degrees Celsius.
